(19) United States
(12) Patent Application Publication
(10) Pub. No.: US 2025/0069820 A1
(43) Pub. Date: Feb. 27, 2025

(54) SOLID ELECTROLYTIC CAPACITOR AND METHOD FOR MANUFACTURING SOLID ELECTROLYTIC CAPACITOR

(71) Applicant: Panasonic Intellectual Property Management Co., Ltd., Osaka (JP)

(72) Inventor: Masahiko TAIRA, KYOTO FU (JP)

(21) Appl. No.: 18/945,126

(22) Filed: Nov. 12, 2024

Related U.S. Application Data
(63) Continuation of application No. PCT/US2023/016144, filed on Mar. 23, 2023.

(30) Foreign Application Priority Data
May 13, 2022 (JP) 2022-079220

(51) Int. Cl. H01G 9/10; H01G 9/00; H01G 9/012; H01G 9/15

(52) U.S. Cl. CPC H01G 9/10; H01G 9/0029; H01G 9/012; H01G 9/15

(57) ABSTRACT

A disclosed solid electrolytic capacitor includes at least one capacitor element, an anode lead terminal, a cathode lead terminal, and a packaging resin covering the capacitor element, the anode lead terminal, and the cathode lead terminal. Each of the anode lead terminal and the cathode lead terminal has an exposed portion exposed from the packaging resin and a covered portion covered with the packaging resin. The covered portion has a surface region including a first oxide film, and a second oxide film having a higher brittleness than the first oxide film. The surface region has a first surface region and a second surface region in which the amount of the second oxide film per unit area is smaller than that in the first surface region.

### CROSS REFERENCE TO RELATED APPLICATION

The present application is a continuation application of International Application No. PCT/JP2023/016144, filed on Apr. 24, 2023 and claims priority with respect to the Japanese Patent Application No. 2022-079220 filed on May 13, 2022. The entire contents of these prior applications are incorporated herein by reference.

### TECHNICAL FIELD

The present disclosure relates to a solid electrolytic capacitor and a method for manufacturing a solid electrolytic capacitor.

### BACKGROUND

Conventionally, solid electrolytic capacitors using a solid as an electrolyte have been known (e.g., JP2002-134360A). The solid electrolytic capacitor of JP2002-134360A includes a capacitor element, an anode lead terminal, a cathode lead terminal, and a packaging resin covering them, and each lead terminal is partially exposed from the packaging resin.

### SUMMARY

When atmospheric air enters inside a solid electrolytic capacitor, and the air reaches the capacitor element, a chemical reaction may occur to cause the capacitor element to deteriorate. In order to prevent such deterioration over time, solid electrolytic capacitors are required to have high airtightness. Under such circumstances, the present disclosure provides a technology for improving the airtightness of solid electrolytic capacitors.

One aspect of the present disclosure relates to a solid electrolytic capacitor. The solid electrolytic capacitor includes: at least one capacitor element having an anode section and a cathode section; an anode lead terminal electrically connected to the anode section; a cathode lead terminal electrically connected to the cathode section; a packaging resin covering the capacitor element, the anode lead terminal, and the cathode lead terminal, so as to expose at least part of each of the anode lead terminal and the cathode lead terminal, wherein the anode lead terminal and the cathode lead terminal each have an exposed portion exposed from the packaging resin, and a covered portion covered with the packaging resin, the covered portion has a surface region including a first oxide film, and a second oxide film having a higher brittleness than the first oxide film, and the surface region has a first surface region, and a second surface region in which an amount of the second oxide film per unit area is smaller than that in the first surface region.

Another aspect of the present disclosure relates to a method for manufacturing a solid electrolytic capacitor. The method includes: a first step of preparing at least one capacitor element having an anode section and a cathode section; a second step of preparing a lead frame having a to-be-exposed portion to be exposed from a packaging resin and a to-be-covered portion to be covered with the packaging resin, and having a first oxide film formed on the to-be-covered portion; a third step of placing the capacitor element on the lead frame via a conductive paste; a fourth step of heating the capacitor element and the lead frame, to harden the conductive paste and form a second oxide film having a higher brittleness than the first oxide film on the to-be-covered portion; a fifth step of forming, on the to-be-covered portion, a first surface region in which the first oxide film and the second oxide film are formed, and a second surface region in which the first oxide film is formed, and an amount of the second oxide film per unit area is smaller than that in the first surface region; and a sixth step of covering the capacitor element and the to-be-covered portion with the packaging resin.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a schematic sectional view of an example of a solid electrolytic capacitor according to the present disclosure.

FIG. 2 is a sectional view of an essential part of a solid electrolytic capacitor.

FIGS. 3A to 3C are sectional views showing the changes of an essential section in a method for manufacturing a solid electrolytic capacitor, in which FIG. 3A illustrates a state where a first oxide film is formed.

FIG. 3B illustrates a state where first and second oxide films are formed.

FIG. 3C illustrates a state where a least part of the second oxide film is removed.

### DETAILED DESCRIPTION

Embodiments of a solid electrolytic capacitor and a method for manufacturing a solid electrolytic capacitor according to the present disclosure will be described below by way of examples. The present disclosure, however, is not limited to the examples described below. In the following description, specific numerical values and materials are exemplified in some cases, but other numerical values and other materials may be adopted as long as the effects of the present disclosure can be obtained. In the present specification, the phase “a numerical value A to a numerical value B” includes the numerical value A and the numerical value B, and can be rephrased as “a numerical value A or more and a numerical value B or less.” In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, one kind of them may be selected and used singly, or two or more kinds of them may be used in combination. The present disclosure encompasses a combination of matters recited in any two or more claims selected from plural claims in the appended claims. In other words, as long as no technical contradiction arises, matters recited in any two or more claims selected from plural claims in the appended claims can be combined. Note that the “solid electrolytic capacitor” may be rephrased as an “electrolytic capacitor,” and the “capacitor” may be rephrased as a “condenser.”

### (Solid Electrolytic Capacitor)

A solid electrolytic capacitor according to the present disclosure includes at least one capacitor element, an anode lead terminal, a cathode lead terminal, and a packaging resin.

At least one capacitor element has an anode section and a cathode section. Between the anode section and the cathode section, an insulating section providing electrical insulation therebetween may be disposed. The insulating section may be constituted of, for example, an insulating tape or an insulating resin. Only one capacitor element may be disposed, or a plurality of capacitor elements may be disposed. In the latter case, the plurality of capacitor elements may be stacked with each other.

The anode section may be configured to include a part (a part on one side with reference to the insulating section) of an anode body made of a valve metal included in the capacitor element. The cathode section may be constituted of a solid electrolyte layer and a cathode layer formed in sequence on the surface of a cathode-forming portion which is a remaining part (a part on the other side with reference to the insulating section) of the anode body. A dielectric layer is disposed between the anode body and the solid electrolyte layer. The cathode section may not necessarily include the cathode layer.

Examples of the valve metal constituting the anode body include aluminum, tantalum, niobium, and titanium. The anode body may be a valve metal foil or a sintered body of valve metal particles.

The dielectric layer is formed at least on the surface of the cathode-forming portion which is a remaining part of the anode body. The dielectric layer may be constituted of an oxide (e.g., aluminum oxide) formed on the surface of the anode body by a liquid phase method, such as anodization, or a gas phase method, such as vapor deposition and atomic layer deposition.

The solid electrolyte layer is formed on the surface of the dielectric layer. The solid electrolyte layer may contain a conductive polymer. The solid electrolyte layer may further contain a dopant, as necessary.

As the conductive polymer, a known material used in solid electrolytic capacitors, for example, a π-conjugated conductive polymer and the like can be used. Examples of the conductive polymer include polymers whose backbones are polypyrrole, polythiophene, polyaniline, polyfuran, polyacetylene, polyphenylene, polyphenylenevinylene, polyacene, and polythiophenevinylene. Preferred among them is a polymer whose backbone is polypyrrole, polythiophene, or polyaniline. The above polymers also include a homopolymer, a copolymer of two or more kinds of monomers, and derivatives of them (including a substituted product having a substituent). For example, polythiophene includes poly(3,4-ethylenedioxythiophene) and the like. The conductive polymer may be used singly or in combination of two or more kinds.

As the dopant, for example, at least one selected from the group consisting of a low molecular weight anion and a polyanion is used. The low molecular weight anion includes, for example, a sulfate ion, a nitrate ion, a phosphate ion, a borate ion, an organic sulfonate ion, a carboxylate ion, and the like, but is not limited thereto. Examples of the dopant that generates a sulfonate ion include benzenesulfonic acid, p-toluenesulfonic acid, and naphthalenesulfonic acid. The polyanion includes, for example, a polymer-type polysulfonic acid, a polymer-type polycarboxylic acid, and the like. Examples of the polymer-type polysulfonic acid include polyvinylsulfonic acid, polystyrenesulfonic acid, polyallylsulfonic acid, polyacrylsulfonic acid, and polymethacrylsulfonic acid. Examples of the polymer-type polycarboxylic acid include polyacrylic acid and polymethacrylic acid. The polyanion also includes polyestersulfonic acid, phenolsulfonic acid novolac resin, and the like. The polyanion, however, is not limited thereto.

The solid electrolyte layer may further contain, as necessary, a known additive, and a known conductive material other than the conductive polymer. Such a conductive material include, for example, at least one selected from the group consisting of a conductive inorganic material such as manganese dioxide, and a TCNQ complex salt.

The cathode layer may be constituted of a carbon layer formed on the surface of the solid electrolyte layer, and a conductor layer formed on the surface of the carbon layer. The conductor layer may be constituted of a silver paste. As the silver paste, for example, a composition containing silver particles and a resin component (binder resin) can be used. As the resin component, a thermoplastic resin can be used, but a thermosetting resin, such as an imide-based resin and an epoxy resin, is preferably used.

The anode lead terminal is electrically connected to the anode section of the capacitor element. The anode lead terminal may be connected to the anode section by, for example, laser welding or resistance welding. The constituent material of the anode lead terminal is not particularly limited, and may be, for example, copper or a copper alloy.

The cathode lead terminal is electrically connected to the cathode section of the capacitor element. The cathode lead terminal may be connected to the cathode section via, for example, a conductive paste (e.g., silver paste). The constituent material of the cathode lead terminal is not particularly limited, and may be, for example, copper or a copper alloy.

The packaging resin covers the capacitor element, the anode lead terminal, and the cathode lead terminal such that at least part of each of the anode lead terminal and the cathode lead terminal is exposed. The packaging resin may be constituted of an insulating resin material, and may contain a filler, if necessary. As the insulating resin material, for example, a thermosetting resin containing an epoxy resin as a major component can be used.

The anode lead terminal and the cathode lead terminal each have an exposed portion exposed from the packaging resin and a covered portion covered with the packaging resin. The exposed portion may constitute an external terminal of the solid electrolytic capacitor. The covered portion has a surface region including a first surface region and a second surface region. In the first surface region, a first oxide film and a second oxide film having a higher brittleness than the first oxide film (in other words, more brittle than the first oxide film) are formed. In the first surface region, the first oxide film may be formed on a base material, and the second oxide film may be formed on the first oxide film. In the second surface region, the first oxide film is formed, and the amount of the second oxide film per unit area is smaller than that in the first surface region. In the second surface region, the first oxide film may be formed on the base metal. The first oxide film in the first surface region and the first oxide film in the second surface region may be continuous with each other. The amount of the second oxide film per unit area in the second surface region may be 20% or less, may be 10% or less, may be 5% or less, and may be 1% or less of the amount of the second oxide film per unit area in the first surface region.

The first oxide film may be an oxide film (natural oxide film) that is inevitably present on the base material of each lead terminal. The second oxide film may be an oxide film that grows or is formed more rapidly than the first oxide film during the manufacturing process of a solid electrolytic capacitor (esp., the heat treatment process). The content of the oxygen element to the metal element in the first oxide film may be lower than the content of the oxygen element to the metal element in the second oxide film. The natural oxide film (first oxide film) and the second oxide film can be easily distinguished by a cross-sectional SEM observation or the like. The second oxide film has a higher brittleness than the first oxide film, and is readily removed by any removal method employing thermal, non-thermal, mechanical, chemical, or other treatments. For example, when the amount of the second oxide film removed by irradiating a laser to the second oxide film is larger than the amount of the first oxide film removed by irradiating the laser to the first oxide film, the second oxide film can be regarded as more brittle than the first oxide film. For the laser used when evaluating the brittleness, for example, a UV laser with a peak wavelength of 355 nm and a maximum output of 2 W or more (40 kHz) can be used. As such a laser, for example, MD-U1000C available from Keyence Corporation may be used. The scanning speed of the laser irradiation may be, for example, 250 mm/s.

The inventor has found that the second oxide film which is present at the surface of each lead terminal is a cause that reduces the airtightness of the solid electrolytic capacitor. In other words, even though adhering to the packaging resin that covers each lead terminal, the second oxide film which is more brittle than the first oxide film crumbles relatively easily. At the place where the second oxide film crumbles, tiny gaps are formed between each lead terminal and the packaging resin, and these gaps form a path for outside air to intrude. Regarding this, as described above, each lead terminal of the solid electrolytic capacitor of the present disclosure has a second surface region where the amount of the second oxide film per unit area is small. In the second surface region, since the second oxide film which is susceptible to crumbling is not much present, the state of adhesion between each lead terminal and the packaging resin is maintained, and the intrusion path of outside air is unlikely to be formed. Thus, the airtightness of the solid electrolytic capacitor can be improved.

In each of the anode lead terminal and cathode lead terminal, the second surface region may be provided at least in the vicinity of the exposed portion in the covered portion. The vicinity of the exposed portion in the covered portion can also be said as the vicinity of the root in appearance of each lead terminal. Such an area corresponds to an entrance of the path for outside air to intrude into the solid electrolytic capacitor, and by providing the second surface region at least in this area, the intrusion of outside air can be effectively suppressed.

In each of the anode lead terminal and the cathode lead terminal, the second surface region may be provided on both principal surfaces. With this configuration, it is possible to suppress the formation of an outside air intrusion path over a wider area than when the second surface region is provided only on one of the principal surfaces. The second surface region may also be provided on a side surface connecting both principal surfaces.

### (Method for Manufacturing Solid Electrolytic Capacitor)

The method of manufacturing a solid electrolytic capacitor according to the present disclosure includes a first step, a second step, a third step, a fourth step, a fifth step, and a sixth step.

In the first step, at least one capacitor element having an anode section and a cathode section is prepared. Only one capacitor element may be prepared, or a plurality of capacitor elements may be prepared.

In the second step, a lead frame having a to-be-exposed portion to be exposed from a packaging resin and a to-be-covered portion to be covered with the packaging resin, and having a first oxide film formed on the to-be-covered portion are prepared. The constituent material of the lead frame is not particularly limited, and may be, for example, copper or a copper alloy. The first oxide film may be an oxide film that is inevitably present on a base material of the lead frame. The first oxide film may also be formed on the to-be-exposed portion.

In the third step, the capacitor element is placed on the lead frame via a conductive paste (e.g., silver paste). The conductive paste may also be applied on the cathode section of the capacitor element.

In the fourth step, the capacitor element and the lead frame are heated, so that the conductive paste is hardened, and a second oxide film having a higher brittleness than the first oxide film (in other words, more brittle than the first oxide film) is formed on the to-be-covered portion. The content of the oxygen element to the metal element in the second oxide film may be higher than the content of the oxygen element to the metal element in the first oxide film.

In the fifth step, on the to-be-covered portion, a first surface region in which the first oxide film and the second oxide film are formed, and a second surface region in which the first oxide film is formed, and the amount of the second oxide film per unit area is smaller than that in the first surface region are formed. The first surface region may be a surface region that maintains the surface state formed in the fourth step. The second surface region may be a surface region which is formed by removing at least part of the second oxide film from the surface state formed in the fourth step. The method for removing the second oxide film is not particularly limited, and any removal method employing thermal, non-thermal, mechanical, chemical, or other treatments can be used. Note that, prior to the fifth step, it is preferable to join the anode section of the capacitor element and the lead frame to each other by, for example, welding.

In the sixth step, the capacitor element and the to-be-covered portion are covered with the packaging resin.

In the solid electrolytic capacitor manufactured by the method including the above first to sixth steps, each lead terminal formed by processing the lead frame has the second surface region at a portion corresponding to the to-be-covered portion (i.e., the aforementioned covered portion). Therefore, the intrusion path of outside air is unlikely to be formed, and the airtightness of the solid electrolytic capacitor can be improved.

In the fifth step, the second surface region may be formed by irradiating a laser to the to-be-covered portion. The laser irradiation can remove, on the surface of part of the to-be-covered portion, at least part of the second oxide film. The surface region from which at least part of the second oxide film has been removed constitutes the second surface region. The removal may be performed by scanning a laser over an area from which the second oxide film is desired to be removed.

In the fifth step, the second surface region may be formed at least in the vicinity of the to-be-exposed portion in the to-be-covered portion. The vicinity of the to-be-exposed portion in the to-be-covered portion can also be said as the vicinity of the root in appearance of each lead terminal in a finished solid electrolytic capacitor. Such an area corresponds to an entrance of the path for outside air to intrude into the solid electrolytic capacitor, and by providing the second surface region at least in this area, the intrusion of outside air can be effectively suppressed. In a region irradiated with the laser, as a result of removing the second oxide film, a line-shaped laser irradiation mark is formed. The appearance of the laser irradiation mark differs from that of a region not irradiated with the laser. Therefore, in the present disclosure, the feature that “the covered portion has a first oxide film and a second oxide film having a higher brittleness than the first oxide film, and has a first surface region and a second surface region in which the amount of the second oxide film per unit area is smaller than that in the first surface region” may be rephrased as that “the covered portion has a line-shaped laser irradiation mark in the vicinity of the root of the exposed portion of at least one of the lead terminals.”

In the fifth step, the second surface region may be formed on both principal surfaces of the to-be-covered portion. With this configuration, it is possible to suppress the formation of an outside air intrusion path over a wider area in a finished solid electrolytic capacitor than when the second surface region is formed only on one of the principal surfaces. The second surface region may also be formed on a side surface connecting both principal surfaces.

As described above, according to the present disclosure, since each lead terminal is provided with a second surface region including not much second oxide film which is brittle, the airtightness of the solid electrolytic capacitor can be improved.

In the following, examples of the solid electrolytic capacitor and the method for manufacturing a solid electrolytic capacitor according to the present disclosure will be specifically described with reference to the drawings. To the components and processes of the below-described examples of the solid electrolytic capacitor and the method for manufacturing a solid electrolytic capacitor, the components and processes as described above can be applied. The components and processes of the below-described examples of the solid electrolytic capacitor and the method for manufacturing a solid electrolytic capacitor can be modified based on the description above. The matters as described below may be applied to the above embodiments. Of the components and processes of the below-described examples of the solid electrolytic capacitor and the method for manufacturing a solid electrolytic capacitor, the components and processes which are not essential to the solid electrolytic capacitor and the method for manufacturing a solid electrolytic capacitor according to the present disclosure may be omitted. The figures below are schematic and not intended to accurately reflect the shape and the number of the actual members.

### (Solid Electrolytic Capacitor)

A solid electrolytic capacitor 10 of the present embodiment is of a type in which each lead terminal extends outward from the side and bent along the bottom of the packaging resin, but not limited thereto. For example, the solid electrolytic capacitor 10 may be of a so-called bottom terminal type (each lead terminal is exposed from the bottom of the packaging resin). In addition, in the solid electrolytic capacitor 10 of the present embodiment, the capacitor elements are all oriented in the same direction, but not limited thereto, and some of the capacitor elements and the remaining capacitor elements may be oriented in opposite directions. In the latter case, the directions of the current flowing through some of the capacitor elements and the current flowing through the remaining capacitor elements will be opposite from each other, and the magnetic fields of the two currents will cancel out each other. Therefore, the ESL of the solid electrolytic capacitor 10 can be reduced.

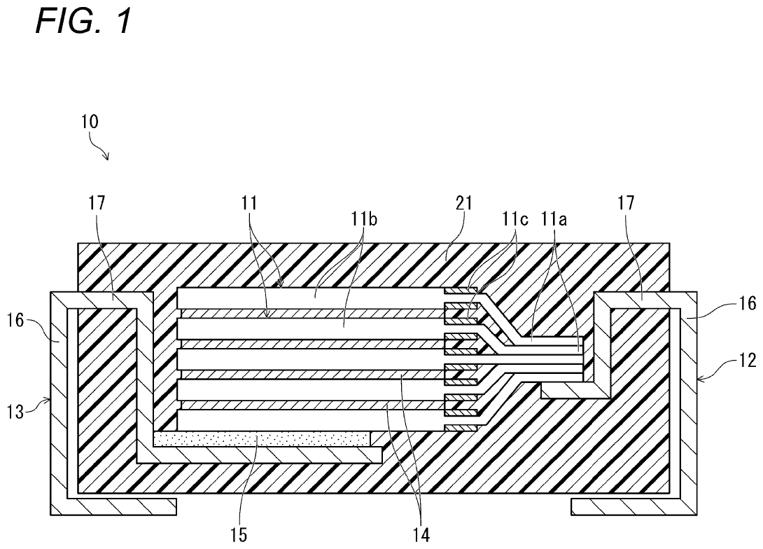

As illustrated in FIG. 1, the solid electrolytic capacitor 10 includes a plurality of (five, in this example) capacitor elements 11, an anode lead terminal 12, a cathode lead terminal 13, and a packaging resin 21.

The capacitor elements 11 are stacked with each other. Each capacitor element 11 has an anode section 11a and a cathode section 11b. Between the anode section 11a and the cathode section 11b, an insulating section 11c for providing electrical insulation therebetween is disposed.

The anode sections 11a adjacent to each other in the stacking direction are connected to each other by welding (e.g., laser welding or resistance welding). The cathode sections 11b adjacent to each other in the stacking direction are connected to each other with a conductive material 14. The conductive material 14 is constituted of, for example, a silver paste.

The anode lead terminal 12 is electrically connected to the anode sections 11a of the capacitor element 11. The anode lead terminal 12 is connected to the anode sections 11a by welding (e.g., laser welding or resistance welding). The anode lead terminal 12 in the present embodiment is constituted of a copper alloy, but not limited thereto. The shape of the anode lead terminal 12 is not limited to the illustrated one, and can be designed as desired.

The cathode lead terminal 13 is electrically connected to the cathode sections 11b of the capacitor element 11. The cathode lead terminal 13 is connected to the cathode sections 11b via a conductive paste 15. The conductive paste 15 is constituted of, for example, a silver paste. The cathode lead terminal 13 in the present embodiment is constituted of a copper alloy, but not limited thereto. The shape of the cathode lead terminal 13 is not limited to the illustrated one, and can be designed as desired.

The packaging resin 21 covers the plurality of the capacitor elements 11, the anode lead terminal 12, and the cathode lead terminal 13 such that a part (an exposed portion 16 described below) of each of the anode lead terminal 12 and the cathode lead terminal 13 is exposed. The packaging resin 21 is constituted of an insulating resin material.

The anode lead terminal 12 and the cathode lead terminal 13 each have the exposed portion 16 exposed from the packaging resin 21, and a covered portion 17 covered with the packaging resin 21. The exposed portion 16 constitutes an external terminal of the solid electrolytic capacitor 10.

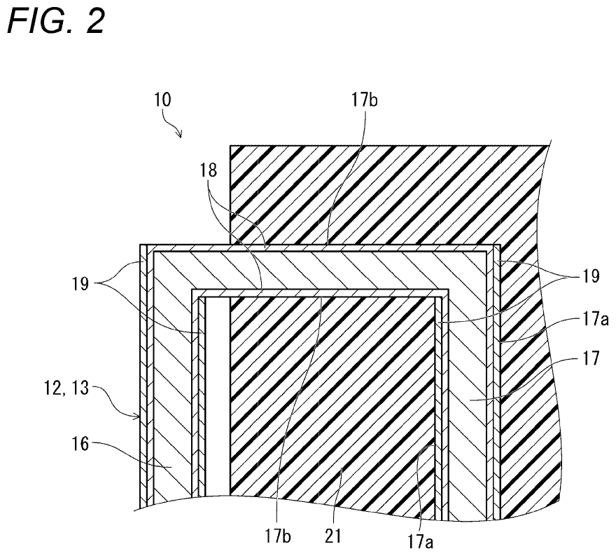

As illustrated in FIG. 2, the covered portion 17 has a surface region including a first surface region 17a and a second surface region 17b. In FIG. 2, for the sake of convenience, both the anode lead terminal 12 and the cathode lead terminal 13 are shown in the same orientation.

In the first surface region 17a, a first oxide film 18 and a second oxide film 19 having a higher brittleness than the first oxide film 18 are formed. In the second surface region 17b, the first oxide film 18 is formed, and the amount of the second oxide film 19 per unit area is smaller than that in the first surface region 17a. For example, the amount of the second oxide film 19 per unit area in the second surface region 17b may be 5% or less of the amount of the second oxide film 19 per unit area in the first surface region 17a.

In each of the anode lead terminal 12 and the cathode lead terminal 13, the second surface region 17b is provided at least in the vicinity of the exposed portion 16 in the covered portion 17. It is desirable that the dimension of the second surface region 17b formed from the boundary between the exposed portion 16 and the covered portion 17 to the covered portion 17 side is, for example, 100 μm or more. In each of the anode lead terminal 12 and the cathode lead terminal 13, the second surface region 17b is provided on both principal surfaces.

### (Method for Manufacturing Solid Electrolytic Capacitor)

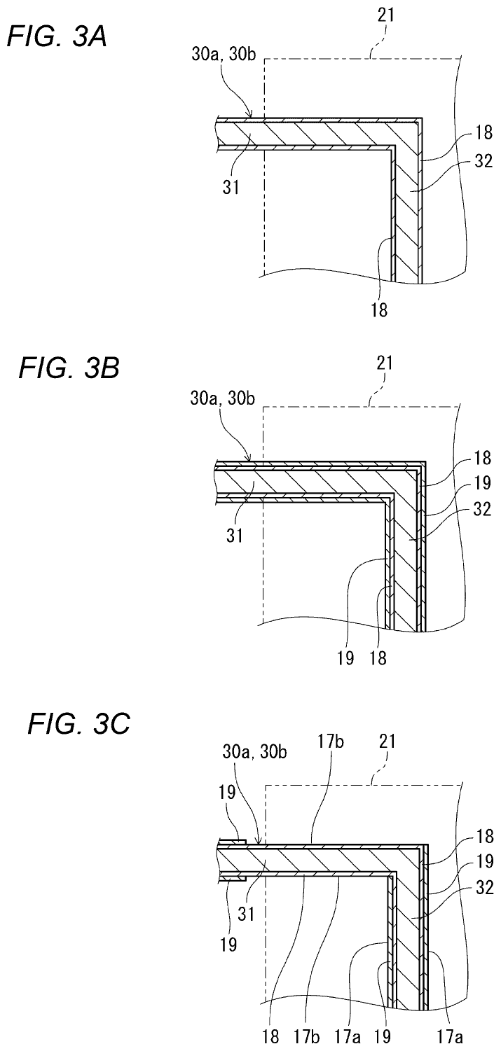

Next, a method of manufacturing the above-described solid electrolytic capacitor 10 will be described with reference to FIGS. 3A to 3C as necessary. For the sake of convenience, in FIGS. 3A to 3C, a lead frame 30a corresponding to the anode lead terminal 12 and a lead frame 30b corresponding to the cathode lead terminal 13 are shown in the same orientation. In FIGS. 3A to 3C, the packaging resin 21 in the finished product is shown by a two-dot-dash line.

The method for manufacturing a solid electrolytic capacitor includes a first step, a second step, a third step, a fourth step, a fifth step, and a sixth step.

In the first step, a plurality of the capacitor elements 11 each having the anode section 11a and the cathode section 11b are prepared.

In the second step, the lead frames 30a and 30b each having a to-be-exposed portion 31 and a to-be-covered portion 32, and each having the first oxide film 18 formed on the to-be-covered portion 32 are prepared (FIG. 3A). The to-be-exposed portion 31 is a portion to be exposed from the packaging resin 21, and corresponds to the exposed portion 16 of the finished solid electrolytic capacitor 10. The to-be-covered portion 32 is a portion to be covered with the packaging resin 21, and corresponds to the covered portion 17 of the finished solid electrolytic capacitor 10.

In the third step, a plurality of the capacitor elements 11 are placed on the lead frames 30a and 30b via the conductive paste 15. The conductive paste 15 is applied onto the cathode section 11b of the capacitor element 11. In the third step, the plurality of the capacitor elements 11 are stacked with each other with the conductive material 14 therebetween.

In the fourth step, the capacitor elements 11 and the lead frames 30a and 30b are heated, so that the conductive paste 15 and the conductive material 14 are hardened, and the second oxide film 19 having a higher brittleness than the first oxide film 18 is formed on the to-be-covered portion 32 (FIG. 3B).

In the fifth step, the first surface region 17a and the second surface region 17b are formed on the to-be-covered portion 32. The first surface region 17a is a surface region in which the first oxide film 18 and the second oxide film 19 are formed. The second surface region 17b is a surface region in which the first oxide film 18 is formed, and the amount of the second oxide film 19 per unit area is smaller than that in the first surface region 17a (FIG. 3C).

In the fifth step, the second surface region 17b is formed by irradiating a laser to the to-be-covered portion 32. In the fifth step, the second surface region 17b is formed at least in the vicinity of the to-be-exposed portion 31 in the to-be-covered portion 32. In the fifth step, the second surface region 17b is formed on both principal surfaces of the to-be-covered portion 32. The laser may be irradiated in a line shape along the boundary between the to-be-covered portion 32 and the to-be-exposed portion 31. The number of times of irradiation (or scanning) of the laser may be, for example, 1 to 3, and is preferably 1. The laser may be a CW laser or a pulsed laser. The dimension of the second surface region 17b formed from the boundary between the to-be-exposed portion 31 and the to-be-covered portion 32 to the to-be-covered portion 32 side may be approximately the same as the beam diameter of the laser, and may be, for example, 100 μm or more.

In the sixth step, the plurality of the capacitor elements 11 and the to-be-covered portion 32 are covered with the packaging resin 21. Through subsequent steps, such as a bending step of bending the lead frames 30a and 30b along the outer surface of the packaging resin 21, the solid electrolytic capacitor 10 is finished.

### Examples

The solid electrolytic capacitors 10 of Example and Comparative Example shown below were subjected to a gross leak test, to evaluate their airtightness. The gross leak test was performed in accordance with the US military standard MIL-STD-883. The number of samples was 100 each for Example and Comparative Example.

### Example

The solid electrolytic capacitor 10 was evaluated. In the production process of the solid electrolytic capacitor 10, the second surface region 17b was formed by irradiating a laser to the to-be-covered portion 32 before covering with the packaging resin 21. Here, a UV laser (MD-U1000C available from Keyence Corporation) was used, and the scanning speed of the laser irradiation was set to 250 mm/s. Thus, the first surface region 17a and the second surface region 17b were formed in the covered portion 17 of the finished solid electrolytic capacitor 10. The amount of reduction in pressure in the gross leak test was 100 (dimensionless reference value) on average.

### Comparative Example

A solid electrolytic capacitor of the same type was evaluated. The solid electrolytic capacitor was produced through the same process as the solid electrolytic capacitor 10 of Example, except that the laser irradiation to the to-be-covered portion 32 was not performed. The amount of reduction in pressure in the gross leak test was 1712 (dimensionless) on average.

As described above, the amount of reduction in pressure in the solid electrolytic capacitor 10 of Example was considerably smaller than that in the solid electrolytic capacitor of Comparative Example. Here, according to the gross leak test, the smaller the amount of reduction in pressure is, the higher the airtightness is. It can be said therefore that the superiority of Example was shown.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

The present disclosure can be applicable for a solid electrolytic capacitor and a method for manufacturing a solid electrolytic capacitor.

### REFERENCE NUMERALS

10: solid electrolytic capacitor
   11: capacitor element
      11a: anode section
      11b: cathode section
      11c: insulating section
   12: anode lead terminal
   13: cathode lead terminal
   14: conductive material
   15: conductive paste
   16: exposed portion
   17: covered portion
      17a: first surface region
      17b: second surface region
   18: first oxide film
   19: second oxide film
   21: packaging resin
30a, 30b: lead frame
   31: to-be-exposed portion
   32: to-be-covered portion

What is claimed is:

1. A solid electrolytic capacitor, comprising:
at least one capacitor element having an anode section and a cathode section;
an anode lead terminal electrically connected to the anode section;
a cathode lead terminal electrically connected to the cathode section;
a packaging resin covering the capacitor element, the anode lead terminal, and the cathode lead terminal, so as to expose at least part of each of the anode lead terminal and the cathode lead terminal, wherein
the anode lead terminal and the cathode lead terminal each have an exposed portion exposed from the packaging resin, and a covered portion covered with the packaging resin,
the covered portion has a surface region including a first oxide film, and a second oxide film having a higher brittleness than the first oxide film, and
the surface region has a first surface region, and a second surface region in which an amount of the second oxide film per unit area is smaller than that in the first surface region.

2. The solid electrolytic capacitor according to claim 1, wherein, in each of the anode lead terminal and the cathode lead terminal, the second surface region is provided at least in a vicinity of the exposed portion in the covered portion.

3. The solid electrolytic capacitor according to claim 1, wherein, in each of the anode lead terminal and the cathode lead terminal, the second surface region is provided on both principal surfaces.

4. A method for manufacturing a solid electrolytic capacitor, the method comprising:
a first step of preparing at least one capacitor element having an anode section and a cathode section;
a second step of preparing a lead frame having a to-be-exposed portion to be exposed from a packaging resin and a to-be-covered portion to be covered with the packaging resin, and having a first oxide film formed on the to-be-covered portion;
a third step of placing the capacitor element on the lead frame via a conductive paste;
a fourth step of heating the capacitor element and the lead frame, to harden the conductive paste and form a second oxide film having a higher brittleness than the first oxide film on the to-be-covered portion;
a fifth step of forming, on the to-be-covered portion, a first surface region in which the first oxide film and the second oxide film are formed, and a second surface region in which the first oxide film is formed, and an amount of the second oxide film per unit area is smaller than that in the first surface region; and
a sixth step of covering the capacitor element and the to-be-covered portion with the packaging resin.

5. The method for manufacturing a solid electrolytic capacitor according to claim 4, wherein in the fifth step, the second surface region is formed by irradiating a laser to the to-be-covered portion.

6. The method for manufacturing a solid electrolytic capacitor according to claim 4, wherein in the fifth step, the second surface region is formed at least in a vicinity of the to-be-exposed portion in the to-be-covered portion.

7. The method for manufacturing a solid electrolytic capacitor according to claim 4, wherein in the fifth step, the second surface region is formed on both principal surfaces of the to-be-covered portion.
